(19) United States
(12) Patent Application Publication
(10) Pub. No.: US 2024/0229521 A1
(43) Pub. Date: Jul. 11, 2024

(54) DEFORMABLE STRIKER APPARATUS FOR A VEHICLE TAILGATE

(71) Applicant: JAGUAR LAND ROVER LIMITED, Whitley, Coventry, Warwickshire (GB)

(72) Inventor: Kevin WELCH, Coventry, Warwickshire (GB)

(21) Appl. No.: 18/285,372

(22) PCT Filed: Mar. 18, 2022
(86) PCT No.: PCT/EP2022/057180

§ 371 Date: Oct. 2, 2023

(30) Foreign Application Priority Data
Mar. 31, 2021 (GB) 2104572.9

(51) Int. Cl. E05B 85/04; E05B 77/04; E05B 83/20

(52) U.S. Cl. CPC E05B 85/045; E05B 77/04; E05B 83/20

(57) ABSTRACT

A striker apparatus (40) for a latching system (12) of a vehicle (10), the latching system configured to secure a tailgate (30) of the vehicle, wherein the striker apparatus comprises:
a displaceable portion (41) to which a striker (43) is connected; and
a rigid portion (42) connected to the displaceable portion (41),
wherein the striker apparatus (40) is configured to deform to enable the displaceable portion (41) to displace relative to the rigid portion (42) while remaining connected to the rigid portion (42), as a result of one of the striker apparatus (40) or a latch apparatus (50) of the latching system (12) being translated in a vehicle-inboard direction relative to the other of the striker apparatus (40) or the latch apparatus (50) while the striker (43) is latched to the latch apparatus (50).

### TECHNICAL FIELD

The present disclosure relates to deformable striker apparatus for a vehicle tailgate. In particular, but not exclusively it relates to the striker apparatus having a deformable hinge formation.

### BACKGROUND

Tailgate systems for vehicles are known. Split tailgate systems for vehicles are also known. A split tailgate system comprises a lower tailgate which is lowerable, and an upper tailgate which is raisable. The lower tailgate is lowerable to an open position to enable access to a load carrying compartment of the vehicle such as a rear boot (rear trunk). The upper tailgate is raisable to an open position to enable access to the load carrying compartment of the vehicle.

The upper tailgate and lower tailgate may be arranged to move independently and/or may be arranged to move together.

The upper tailgate and lower tailgate may be latchable to each other when in their respective closed positions. A striker apparatus on one of the tailgates may be aligned with a latch apparatus on the other of the tailgates, so that closing the tailgates results in a striker of the striker apparatus being latched by the latch apparatus.

If the vehicle is struck from behind, it is desirable for the upper and lower tailgates to remain latched to each other. However, if the impact contact point strikes only the lower tailgate but not the upper tailgate, the lower tailgate will translate in a vehicle-inboard direction relative to the upper tailgate. Similarly, for a non-split tailgate system, if the impact contact point strikes below the tailgate, the vehicle body will translate in a vehicle-inboard direction relative to the tailgate. This differential translation will result in a transient force/acceleration peak through the latching system (striker apparatus and latch apparatus). If the high-g acceleration overcomes the inertia of a lightweight latching mechanism, the latching mechanism may move in a way that de-latches the striker apparatus.

Previously, if rear impact tests identified a possibility of de-latching, the skilled person would reinforce the latching system to add stiffness, at the expense of added weight. Such discoveries would generally be made during physical testing, with limited freedom to re-design and re-tool components.

### SUMMARY OF THE INVENTION

It is an aim of the present invention to provide an improved latching system. The invention is as defined in the appended independent claims.

According to an aspect of the invention there is provided a striker apparatus for a latching system of a vehicle, the latching system configured to secure a tailgate of the vehicle, wherein the striker apparatus comprises:
a displaceable portion to which a striker is connected; and
a rigid portion connected to the displaceable portion,
wherein the striker apparatus is configured to deform to enable the displaceable portion to displace relative to the rigid portion while remaining connected to the rigid portion, as a result of one of the striker apparatus or a latch apparatus of the latching system being translated in a vehicle-inboard direction relative to the other of the striker apparatus or the latch apparatus while the striker is latched to the latch apparatus.

It was surprisingly discovered that promoting deformation of the striker apparatus can reduce the likelihood of de-latching, as opposed to adding reinforcement. This is because some impacts may not physically damage the connection between the latch and the striker, but instead may transmit an acceleration through a striker-latch connection that causes mechanisms to move, resulting in self-de-latching. A deformable striker extends the force duration, resulting in reduced peak acceleration to the latch. This reduces the chance of self-de-latching.

In some examples, the displaceable portion and the rigid portion are adjacent portions of a layer of material.

In some examples, the layer is a structural plate.

In some examples, the displaceable portion is centrally located between the rigid portion and another rigid portion.

In some examples, the striker apparatus comprises a reduced cross-section portion connecting the rigid portion and the displaceable portion to one another, having a reduced cross-section compared to the displaceable portion, and configured to deformably displace to enable the displaceable portion to displace.

In some examples, a thickness of the portion of reduced cross-section is substantially the same as a thickness of the displaceable portion and of the rigid portion.

In some examples, the reduced cross-section portion comprises: a slot demarcating the displaceable portion from the rigid portion; and material bridging the slot, the material configuring how far the displaceable portion can displace while remaining connected to the rigid portion.

In some examples, the reduced cross-section portion is configured to enable the displacement to comprise rotation out-of-plane relative to the rigid portion.

In some examples, the reduced cross-section portion is configured so that the rotation can be at least 12 degrees without fracture of the striker apparatus.

In some examples, the reduced cross-section portion is configured as a hinge formation to enable the rotation.

In some examples, the hinge formation bridges the slot, demarcating the displaceable portion from the rigid portion.

In some examples, the striker apparatus is configured to be secured to the tailgate, wherein the hinge formation is to a vehicle-outboard side of the striker apparatus.

In some examples, the striker apparatus comprises a material and geometry configured to withstand, without fracture, a static tension force through the striker of at least 14 kN.

In some examples, the rigid portion comprises a fixing portion configured to enable the striker apparatus to be secured to the vehicle.

In some examples, the fixing portion comprises a fixing aperture.

According to an aspect of the invention there is provided a striker apparatus for a latching system of a vehicle, the latching system configured to secure a lower tailgate and an upper tailgate of a power split tailgate system of the vehicle to one another, wherein the striker apparatus comprises:
a displaceable portion to which a striker is connected; and
a rigid portion connected to the displaceable portion,
wherein the striker apparatus is configured to deform to enable the displaceable portion to displace relative to the rigid portion while remaining connected to the rigid portion, as a result of one of the lower tailgate or the upper tailgate being translated in a vehicle-inboard direction relative to the other of the lower tailgate or the upper tailgate while the striker is latched.

According to an aspect of the invention there is provided a striker apparatus for an upper tailgate of a split tailgate system of a vehicle, wherein the striker apparatus comprises:
a displaceable portion to which a striker is connected; and
a rigid portion connected to the displaceable portion,
wherein the striker apparatus is configured to deform to enable the displaceable portion to displace relative to the rigid portion while remaining connected to the rigid portion, as a result of one of the lower tailgate or the upper tailgate being translated in a vehicle-inboard direction relative to the other of the lower tailgate or the upper tailgate while the striker is latched.

In some examples, the striker apparatus comprises a hinge formation configured to enable the displacement to comprise rotation out-of-plane relative to the rigid portion, wherein the hinge formation is to a vehicle-inboard side of the striker apparatus.

According to an aspect of the invention there is provided a striker apparatus for a latching system of a vehicle, the latching system configured to secure a lower tailgate and an upper tailgate of a split tailgate system of the vehicle to one another, wherein the striker apparatus comprises:
a displaceable portion to which a striker is connected; and
a rigid portion connected to the displaceable portion,
wherein the striker apparatus is configured to deform to enable the displaceable portion to displace relative to the rigid portion while remaining connected to the rigid portion, as a result of one of the lower tailgate or the upper tailgate being translated in a vehicle-inboard direction relative to the other of the lower tailgate or the upper tailgate while the striker is latched.

According to an aspect of the invention there is provided a latching system comprising one of the striker apparatuses previously described, and a latch apparatus. According to an aspect of the invention there is provided a tailgate system comprising a tailgate, a latch apparatus and the striker apparatus previously described. According to an aspect of the invention there is provided a split tailgate system comprising an upper tailgate, a lower tailgate, a latch apparatus and the striker apparatus previously described. The striker apparatus may be supported by the lower tailgate and the latch apparatus may be supported by the upper tailgate. The striker apparatus may be supported by the upper tailgate and the latch apparatus may be supported by the lower tailgate. According to an aspect of the invention there is provided a vehicle comprising the tailgate system or the split tailgate system previously described.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIGS. 2A and 2B illustrate examples of a latching system of a power split tailgate system;

FIG. 3 illustrates an example top view of a striker apparatus;

FIG. 4 illustrates an example end view of a striker apparatus;

FIG. 5 illustrates an example deformed specimen of a striker apparatus;

FIG. 6 illustrates an example end view of a striker apparatus;

FIG. 7 illustrates an example top view of a striker apparatus; and

FIG. 8 illustrates an example of a non-split tailgate system.

### DETAILED DESCRIPTION

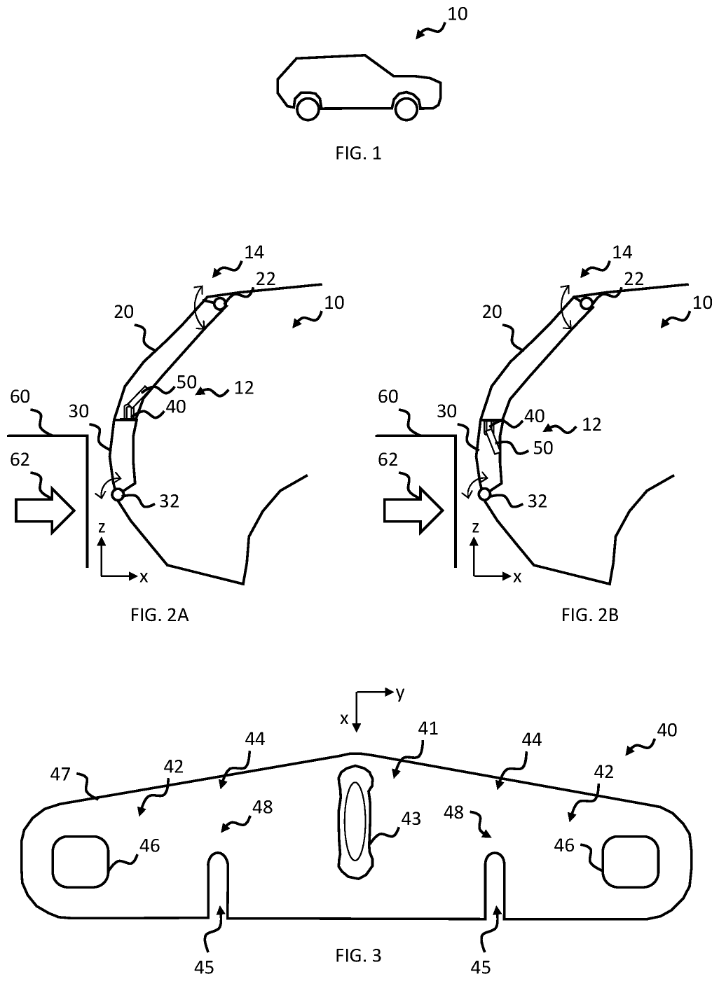

FIG. 1 illustrates an example of a vehicle 10 in which embodiments of the invention can be implemented. In some, but not necessarily all examples, the vehicle 10 is a passenger vehicle, also referred to as a passenger car or as an automobile. In other examples, embodiments of the invention can be implemented for other applications, such as commercial vehicles.

FIGS. 2A and 2B illustrate two examples of a side cross-section of a rear of a vehicle 10, showing components of a power split tailgate system 14. The illustrated lower tailgate 30 is lowerable about a lower hinge 32 to an open position. The illustrated upper tailgate 20 is raisable about an upper hinge 22 to an open position. Therefore, the lower and upper tailgate 30, 20 are horizontally split. The lower and upper tailgates 30, 20 are shown in their closed position in which they are latched to each other.

In some, but not necessarily all examples, the split tailgate system 14 is a ‘power’ split tailgate system. This means that the split tailgate system 14 has one or more of the following functions:
the lower tailgate 30 is lowerable by an actuator without user intervention to an open position;
the lower tailgate 30 is raisable by an actuator without user intervention to a closed position;
the upper tailgate 20 is raisable by an actuator without user intervention to an open position; or
the upper tailgate 20 is lowerable by an actuator without user intervention to a closed position.

An actuation as described above can be requested by a user providing input to a human-machine interface. For example, the user could press a button on their key fob or personal device (for example smartphone) or a button on part of the vehicle 10.

FIGS. 2A and 2B also illustrate a latching system 12 comprising a striker apparatus 40 and a latch apparatus 50. The striker apparatus 40 comprises a striker such as the illustrated loop-shaped section. Alternatively, the striker can be a different shape than a loop. The striker apparatus 40 may comprise a metal such as steel.

The latch apparatus 50 is schematically illustrated by a block that is shown attached to the striker apparatus 40. The latch apparatus 50 comprises various internal components (not visible) such as a claw configured to receive the striker 43, and a pawl configured to prevent the claw from releasing the striker if the latch apparatus 50 is locked.

FIG. 2A illustrates a first example in which the lower tailgate 30 supports the striker apparatus 40 and the upper tailgate 20 supports the latch apparatus 50. For example, the striker apparatus 40 can be secured to the lower tailgate 30 by bolts, screws or other fixings. The latch apparatus 50 can be secured to the upper tailgate 20 in a similar way.

FIG. 2B illustrates a second example in which the striker apparatus 40 and the latch apparatus 50 are swapped around. The upper tailgate 20, rather than the lower tailgate 30, supports the striker apparatus 40, and the lower tailgate 30 supports the latch apparatus 50.

FIGS. 2A-2B also illustrate an external body 60 approaching the lower tailgate 30 from behind the vehicle 10. When the illustrated external body impacts the lower tailgate 30, the impact contact point between the external body 60 and the vehicle 10 is below a split line between the lower and upper tailgates 30, 20. The impact contact point is therefore localised to only the lower tailgate 30 but not the upper tailgate 20. The lower tailgate 30 will be translated in a vehicle-inboard direction 62 (illustrated +ve x-axis, towards the front of the vehicle 10). This will cause a transient force through the striker apparatus 40 and the latch apparatus 50.

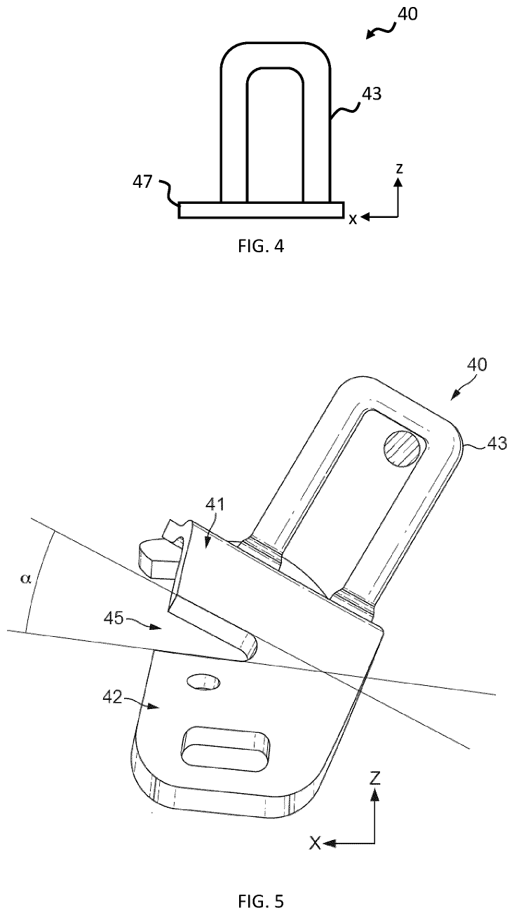

FIGS. 3-5 illustrate an example design of the striker apparatus 40. The striker apparatus 40 has been configured to deform as it is loaded, to reduce peak force/acceleration through the striker apparatus 40 and the latch apparatus 50. This can help the striker apparatus 40 to remain latched to the latch apparatus 50. By remaining latched to each other, both the upper and lower tailgates 20, 30 translate together even though only one of the tailgates is struck, which helps to dissipate force. In addition, neither tailgate swings open so luggage can be kept secure within the vehicle. FIG. 3 illustrates an example top view of the striker apparatus 40. FIG. 4 illustrates an example end view of the striker apparatus 40. FIG. 5 illustrates an example deformed specimen of the striker apparatus 40, after a translation of the lower tailgate 30.

The striker apparatus 40 comprises a striker mounting plate 47 and a striker 43 approximately centrally located between lateral ends of the striker mounting plate 47. The illustrated y-axis extends between the lateral ends.

The illustrated striker mounting plate 47 is elongated in the y-axis (width/lateral dimension), and short in the x-axis (length dimension) due to the limited thickness of the lower tailgate 30 (or upper tailgate 20).

The width of the striker mounting plate 47 can be a value from the range 10 cm to 30 cm. The length of the striker mounting plate 47 can be less than 10 cm. The thickness of the striker mounting plate 47 can be a value from the range approximately 3 mm to approximately 8 mm. In an example, the thickness is approximately 4 mm.

The striker mounting plate 47 is a structural layer of material with a high Youngs Modulus and low brittleness, such as steel or a similar metallic material. An example steel is high strength steel or a higher grade, with a yield of 600 MPa or higher.

The illustrated striker 43 is a loop (FIG. 4), riveted or welded to the striker mounting plate 47 at both ends of the striker 43.

The striker 43 can be oriented perpendicular to the y-axis such that the loop is visible from an end view looking along the y-axis (FIG. 4).

The striker mounting plate 47 can comprise fixing portions 46 configured to enable the striker mounting plate 47 to be secured to the lower tailgate 30 (or upper tailgate 20). In this example, the fixing portions 46 comprise fixing apertures for separate fixings such as screws. In other examples, the fixings are integral or comprise welds.

In FIG. 3, a fixing portion 46 is located to each lateral side of the striker 43. The fixing portions 46 are separated in the y-axis but not in the x-axis. The fixing portions 46 are located proximal to the lateral ends of the striker mounting plate 47.

The striker mounting plate 47 and its fixing apertures can be symmetric about the striker 43 (x-axis).

Overall, the striker apparatus 40 can be configured to withstand, without fracture, a static tension force through the striker 43 of at least 14 kN (static pull test), wholly in the z-axis. This is achieved by configuration of the material and the geometry.

The striker mounting plate 47 has variable deformability between its lateral ends. The illustrated striker mounting plate 47 comprises a deformable portion 44 between each fixing portion 46 and the central portion to which the striker 43 is connected. In use, stress is concentrated at the deformable portions 44, making local plastic deformation at the deformable portion more likely in the event of a rear impact.

By encouraging a portion of the striker mounting plate 47 to deform when the forces are significantly higher than those for opening/closing the tailgate, the central portion 41 to which the striker 43 is connected can displace significantly. This enables the striker 43 to be pulled/rotated in a configured direction to reduce acceleration at the latch apparatus 50. In FIG. 5, the striker 43 has been rotated about the y-axis without tearing of the striker mounting plate 47. In the test, the striker 43 remained latched. Therefore, the peak acceleration was low enough not to overcome the inertia of latching mechanism components and therefore did not cause unintended actuation of the latching mechanism components. Measured g-forces at the striker apparatus 40 were around 150 g, significantly better than the 250 g encountered in a version without slots 45.

The displacement was rotational because of torque about the fixing portions 46. There is torque due to lever arms in the x, y and z axes between the top of the striker 43 and the fixing portions 46. Further, the direction of force may be dynamic during the event.

In the illustrated example, each deformable portion is a reduced cross-section portion 44, comprising a local narrowing of the striker mounting plate 47 to concentrate stress. Alternatively, or additionally, each reduced cross-section portion 44 can comprise a local thinning (z-axis) of the striker mounting plate 47.

The reduced cross-section portions 44 can be created by drilling or moulding channels into the striker mounting plate 47. In the illustrations, each channel is a slot 45 (elongated through-hole). The illustrated slots 45 are parallel to each other and open at a common edge of the striker mounting plate 47 extending perpendicularly from the common edge of the mounting plate. At the end of each slot 45 is a narrow bridge 48 of material connecting the central portion to a rigid portion 42 where the fixing portion 46 is located.

The length of a slot 45 determines the width of the bridge 48. The width of each bridge 48 may be slightly greater than the length of each slot 45. However, the bridges 48 may still represent the narrowest point along the fixing-to-fixing y-axis span of the striker mounting plate 47.

The slots 45 can be positioned along the span/y-axis at any appropriate location. The distance along the y-axis from the centre of the nearest fixing portion 46 to the centre of the slot 45 can be a value from the range between approximately 15% and approximately 40% of the total span length between the fixing portions 46 (centre-to-centre). In the illustration the value is about 25%.

In view of the foregoing, the striker mounting plate 47 can be regarded as having a plurality of portions:
the central, displaceable portion 41 to which the striker 43 is connected;
a deformable, reduced cross-section portion 44 (for example slotted portion) to each lateral side of the central, displaceable portion 41, configured to deform to enable the central portion 41 to displace; and
a rigid portion 42 towards each lateral end, each comprising a fixing portion 46.

The rigid portions 42 are rigid because they are less deformable than the reduced cross-section portions 44 and less displaceable than the central, displaceable portion 41. The rigid portions 42 have a greater average cross-sectional area (x-z section) than the bridges 48, and are less displaceable than the central, displaceable portion 41 by virtue of proximity to fixing portions 46. The striker mounting plate 47 is analogous to a fixed-ended beam, in which displacement is greater towards the middle of the span between the fixing portions 46, and less when close to the fixing portions 46.

The central, displaceable portion 41 is not as deformable as the bridges 48 because the central, displaceable portion 41 has a relatively larger cross-section. The central, displaceable portion 41 has a greater average cross-sectional area (x-z section) than the bridges 48.

As shown in the experimental result of FIG. 5, the central displaceable portion 41 is able to displace (for example rotate and/or translate) as a result of the deformation of the bridges 48 to either side of the central displaceable portion 41.

FIG. 5 illustrates that the central displaceable portion 41 has rotated out-of-plane relative to the previously approximately flat plane of the striker mounting plate 47 (flat notwithstanding a small hump at the central portion 41). The rotation is about the y-axis. Most of the deformation occurred at the bridges 48 of the deformable, reduced cross-section portions 44, as evidenced by the nonzero angle α between one edge of the slot 45 and the other parallel edge of the slot 45. In FIG. 5, α is approximately 18.5 degrees and neither fracture nor de-latching occurred. Before the test, α was approximately 0 degrees. The striker mounting plate 47 can be configured to enable the angle α to be at least 12 degrees without fracture of the striker mounting plate 47.

In FIG. 5, a small amount of further deformation occurred at the rigid portion 42 and the central displaceable portion 41, as they are not infinitely rigid. They are visibly deformed slightly out of a flat plane. There is no visible deformation of the striker 43 itself. This further deformation further contributes to the reduction of force/acceleration through the striker 43.

Based on FIG. 5, the bridges 48 of the deformable, reduced cross-section portions 44 can be regarded as hinge formations that enable the central displaceable portion 41 to rotate by at least the angle α without fracture. They are plastically deformable hinges.

If the power split tailgate system 14 is as shown in FIG. 2A, with the striker apparatus 40 connected to the lower tailgate 30, the striker apparatus 40 can be oriented so that the slots 45 face forwards (+ve x-axis towards front of vehicle 10) and the bridges 48 (hinge formations) face rearwards. That is, the slots 45 are inboard and the hinge formations are outboard. Therefore, if the lower tailgate 30 is translated inboard (+ve x-axis), the rotational displacement of the central displaceable portion 41 will reduce force/acceleration through the striker 43 and resist de-latching.

Alternatively, if the power split tailgate system 14 is as shown in FIG. 2B, with the striker apparatus 40 connected to the upper tailgate 20 in an upside-down orientation compared to FIG. 2A, the striker apparatus 40 can be oriented so that the slots 45 face rearwards and the hinge formations face forwards. Now, the slots 45 are outboard and the hinge formations are inboard. This ensures that force/acceleration is reduced and de-latching is resisted if the lower tailgate 30 is translated inboard.

If the striker apparatus 40 is instead designed to minimise force due to translation of the upper tailgate 20, then the striker apparatus 40 can be facing the opposite way than that described above.

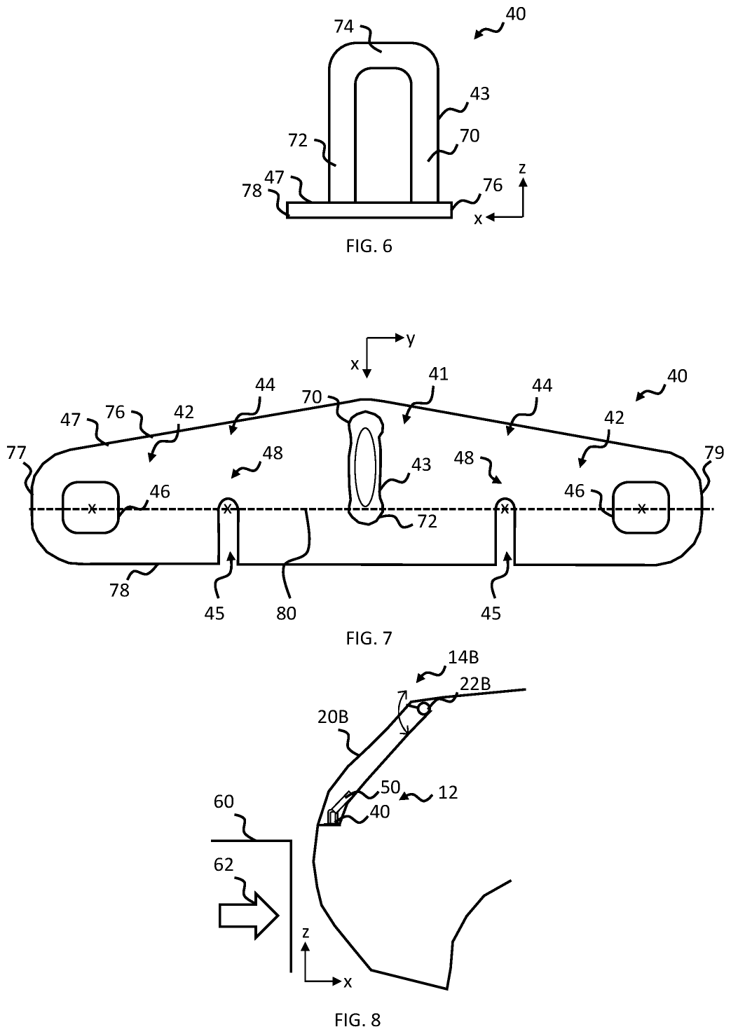

FIGS. 6 and 7 illustrate an end view and a top view, respectively, of the striker apparatus 40. FIG. 7 shows the same striker apparatus as FIG. 3 but with additional reference numerals marked and FIG. 6 shows the same striker apparatus as FIG. 4 but with additional reference numerals marked. The striker apparatus 40 is the same as shown in the previous Figures, unless explicitly stated otherwise.

As shown in FIG. 6, the striker 43 comprises a first leg 70 and a second leg 72. The first leg 70 and the second leg 72 are interconnected by a lateral portion 74 to form a loop.

The first leg 70 connects to the striker mounting plate 47 at a first location and the second leg 72 connects to the striker mounting plate 47 at a second location longitudinally offset from the first location.

The first leg 70 connects to the striker mounting plate 47 at an approximately perpendicular angle. The second leg 72 connects to the striker mounting plate 47 at an approximately perpendicular angle.

As shown in FIGS. 6 and 7, the striker mounting plate 47 comprises a pair of long edges 76, 78 and a pair of short edges 77, 79.

The striker 43 is positioned closer to a first long edge 76 than to a second long edge 78, wherein the slots 45 are formed in the second long edge 78.

A first slot 45 is located between a first short edge 77 and the striker 43. A second slot 45 is located between a second short edge 79 and the striker 43. The striker 43 is at a central position.

A first fixing portion 46 is located between the first short edge 77 and the first slot 45. A second fixing portion 46 is located between the second short edge 79 and the second slot 45.

The slots 45 and/or the fixing portions 46 and/or the long edges 76, 78 and/or the short edges 77, 79 are substantially symmetrical about a longitudinal axis passing through the striker 43 at the centre of the striker apparatus 40. The slots 45 are substantially equidistant from the striker 43.

The slots 45 extend at least as far as the second leg 72 of the striker 43. The distance from the second long edge 78 of the striker mounting plate 47 to the ends of the slots 45 is at least as far as the distance from the second long edge 78 to the second leg 72 of the striker.

The slots 45 may extend at least as far from the second long edge 78 as the fixing portions 46. The distance from the second long edge 78 to the ends of the slots 45 may be at least as far as the distance from the second long edge 78 to the closest edges of the fixing portions 46 to the second long edge 78.

As shown by the line 80 in FIG. 7 extending in the y-axis, the ends of the slots 45 may align with the striker 43 and the fixing portions 46. This alignment encourages the deformation in the required location such that the forces of impact are reduced. In a specific example, the ends of the slots 45 align with the second leg 72. The ends of the slots 45 may align approximately with the centres of the fixing portions 46. The centre of a fixing portion 46 may be defined as the centre of a fixing aperture.

The second long edge 78 in FIG. 7 is a substantially straight edge. The slots 45 are substantially perpendicular to the second long edge 78. The slots 45 extend substantially in parallel to each other. The slots 45 may also be parallel to the striker 43.

The first long edge 76 in FIG. 7 is nonlinear in shape. The first long edge 76 illustrated is nonparallel to the second long edge 78. The illustrated first long edge 76 is further from the second long edge 78 towards the centre of the striker apparatus 40, and closer to the second long edge 78 towards the lateral short edges 77, 79 of the striker apparatus 40. This enables the first leg 70 of the striker 43 to be located past the ends of the slots 45. The illustrated first long edge 76 is approximately V-shaped.

The distance from the second long edge 78 to the first long edge 76 of the striker mounting plate 47 at the location of a slot 45 may be greater than 1.5 times the length of the slot 45 and less than 3 times the length of the slot 45. As shown in the illustrated example, the range may be from 2 to 2.5 times the length of the slot 45. In a specific example, the range is greater than twice the length of a slot 45. In other words, the length of a bridge 48 may be longer than 50% and less than 200% of the length of its corresponding slot 45, or longer than 100% and less than 150% of the length of its corresponding slot 45.

Although embodiments of the present invention have been described in the preceding paragraphs with reference to various examples, it should be appreciated that modifications to the examples given can be made without departing from the scope of the invention as claimed.

For example, a single rigid portion 42 and fixing portion 46 can be provided, instead of a pair to either side of the displaceable portion 41. In some examples, a slot 45 may be replaced with a plurality of gaps, holes or perforations.

FIG. 8 illustrates a non-split tailgate system 14B to which the striker apparatus previously described can be applied. The non-split tailgate system 14B comprises a single tailgate 20B rather than two horizontally-split tailgates. The single tailgate 20B may be top hinged via an upper hinge 22B, for example. The non-split tailgate system 14B may be powered or passive. The striker apparatus 40 may be mounted to either a vehicle body of the vehicle, as shown, or to the tailgate 20B. The height of the lower edge of the tailgate 20B may be above the external body 60 such as a bonnet of an impacting vehicle. Therefore, the vehicle body may translate in a vehicle-inboard direction and the striker apparatus 40 would usefully deform in the manner previously described.

It will be appreciated that various changes and modifications can be made to the present invention without departing from the scope of the present application.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A striker apparatus for a latching system of a vehicle, the latching system configured to secure a tailgate of the vehicle, wherein the striker apparatus comprises:
a displaceable portion to which a striker is connected; and
a rigid portion connected to the displaceable portion,
wherein the striker apparatus is configured to deform to enable the displaceable portion to displace relative to the rigid portion while remaining connected to the rigid portion, as a result of one of the striker apparatus or a latch apparatus of the latching system being translated in a vehicle-inboard direction relative to the other of the striker apparatus or the latch apparatus while the striker is latched to the latch apparatus.

2. The striker apparatus of claim 1, wherein the displaceable portion and the rigid portion are adjacent portions of a layer of material.

3. The striker apparatus of claim 1, wherein the displaceable portion is centrally located between the rigid portion and another rigid portion.

4. The striker apparatus of claim 1, comprising a reduced cross-section portion connecting the rigid portion and the displaceable portion to one another, having a reduced cross-section compared to the displaceable portion, and configured to deformably displace to enable the displaceable portion to displace.

5. The striker apparatus of claim 4, wherein a thickness of the portion of reduced cross-section is substantially the same as a thickness of the displaceable portion and of the rigid portion.

6. The striker apparatus of claim 4, wherein the reduced cross-section portion comprises: a slot demarcating the displaceable portion from the rigid portion; and material bridging the slot, the material configuring how far the displaceable portion can displace while remaining connected to the rigid portion.

7. The striker apparatus of claim 4, wherein the reduced cross-section portion is configured to enable the displacement to comprise rotation out-of-plane relative to the rigid portion.

8. The striker apparatus of claim 7, wherein the reduced cross-section portion is configured so that the rotation can be at least 12 degrees without fracture of the striker apparatus.

9. The striker apparatus of claim 7, wherein the reduced cross-section portion is configured as a hinge formation to enable the rotation.

10. The striker apparatus of claim 6, wherein the reduced cross-section portion is configured to enable the displacement to comprise rotation out-of-plane relative to the rigid portion, the reduced cross-section portion is configured as a hinge formation to enable the rotation, and the hinge formation bridges the slot, demarcating the displaceable portion from the rigid portion.

11. The striker apparatus of claim 9, wherein the striker apparatus is configured to be secured to the tailgate, wherein the hinge formation is to a vehicle-outboard side of the striker apparatus.

12. The striker apparatus of claim 1, wherein the rigid portion comprises a fixing portion configured to enable the striker apparatus to be secured to the vehicle.

13. The striker apparatus of claim 12, wherein the fixing portion comprises a fixing aperture.

14. A tailgate system comprising a tailgate, a latch apparatus and the striker apparatus of claim 1.

15. A power split tailgate system comprising an upper tailgate, a lower tailgate, a latch apparatus and the striker apparatus of claim 1.

16. The power split tailgate system of claim 15, wherein the striker apparatus is supported by the lower tailgate and the latch apparatus is supported by the upper tailgate.

17. The power split tailgate system of claim 15, wherein the striker apparatus is supported by the upper tailgate and the latch apparatus is supported by the lower tailgate.

18. A vehicle comprising the tailgate system of claim 14.

19. A vehicle comprising the power split tailgate system of claim 15.
